(19) United States
(12) Patent Application Publication
(10) Pub. No.: US 2025/0367692 A1
(43) Pub. Date: Dec. 4, 2025

(54) TRIGGER DISPENSING HEAD

(71) Applicant: GUALA DISPENSING S.P.A., Alessandria (IT)

(72) Inventor: Riccardo ALLUIGI, Alessandria (IT)

(21) Appl. No.: 18/874,285

(22) PCT Filed: Jul. 18, 2023
(86) PCT No.: PCT/IB2023/057311

§ 371 Date: Dec. 12, 2024

(30) Foreign Application Priority Data
Jul. 28, 2022 (IT) 102022000016053

(51) Int. Cl. B05B 11/10

(52) U.S. Cl. CPC B05B 11/1011; B05B 11/1069

(57) ABSTRACT

A trigger dispensing head for a dispensing device has a frame, a cylinder wall that delimits a cylinder chamber, a sleeve inserted into the cylinder chamber, a dispensing duct, a suction duct and valves for adjusting a flow of a product to be dispensed. The valves have a valve element having a support wall made of an elastically deformable material that is engaged between the sleeve and the cylinder wall to form a seal against leakage of the product.

### FIELD OF THE INVENTION

The present invention is in the field of trigger dispensing devices, generally used for household and ambient hygiene, ironing clothing, personal care, plant care, animal care, and many other uses.

In particular, the object of the present invention is a trigger dispensing head which is applicable to a bottle of a dispensing device and provided with a system for preventing product leakage.

One fundamentally important aspect of dispensing devices is the need to ensure an effective seal against product leakage under various conditions.

In particular, online trade has led to new requirements and also new problems for the trigger dispensing device industry. On such occasions, in fact, dispensing devices are often stored under less than optimal conditions, for example upside down, arranged in an oversized box together with other goods.

One of the drawbacks encountered is the leakage of product through the venting duct, which places the inner compartment of the bottle in communication with the external environment to ensure that air enters into the bottle during the suction step. In this regard, the Applicant is the holder of Italian patents No. 102021000017402 and No. 102021000003749.

An analogous problem is in relation to the leakage of product from the chamber that houses the valve means of the dispensing head. Document JPS605249A describes a trigger dispensing head provided with system for sealing against product leakage that is based upon moving components and therefore particularly complicated to manufacture.

### OBJECT OF THE INVENTION

The object of the present invention is that of satisfying the requirements of the sector and overcoming the aforementioned drawbacks, by presenting a dispensing head comprising valve means for adjusting the flow of product to be dispensed and configured so as to cooperate with other components of the dispensing head in order to form a seal against product leakage.

This object is achieved by a dispensing head according to claim 1 and the dispensing device according to claim 16. The dependent claims identify additional advantageous embodiments.

### BRIEF DESCRIPTION OF THE DRAWINGS

The features and advantages of the dispensing head according to the present invention will be apparent from the description provided hereinafter, given by way of non-limiting example, in accordance with the figures in the appended drawings, wherein:

FIGS. 1 and 2 depict a trigger dispensing device according to one embodiment of the present invention;

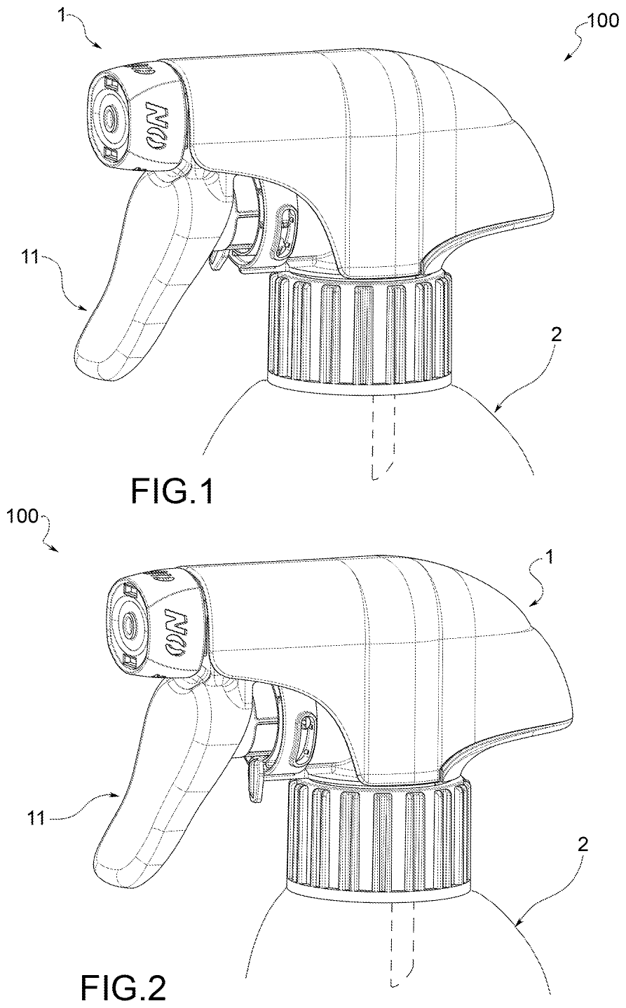

FIG. 3 shows a cross-sectional view of a trigger dispensing head, according to one embodiment of the present invention;

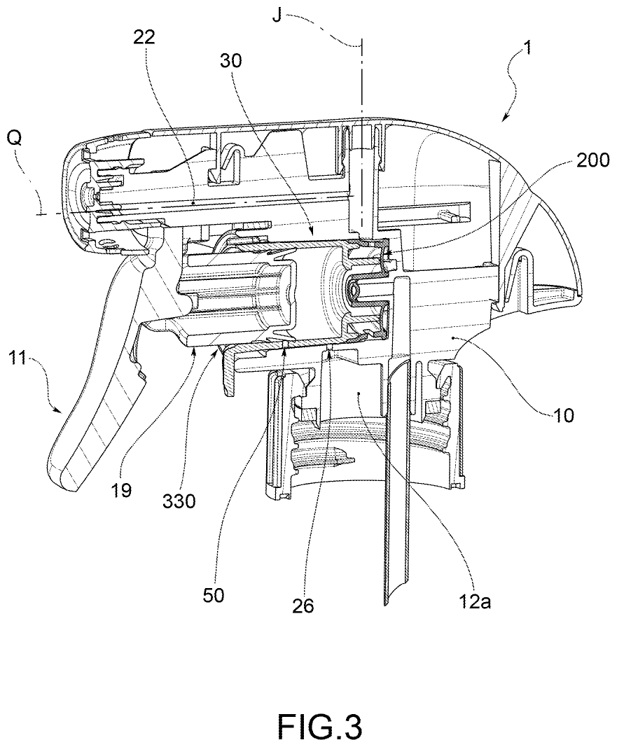

FIG. 3a shows an enlarged detail of FIG. 3;

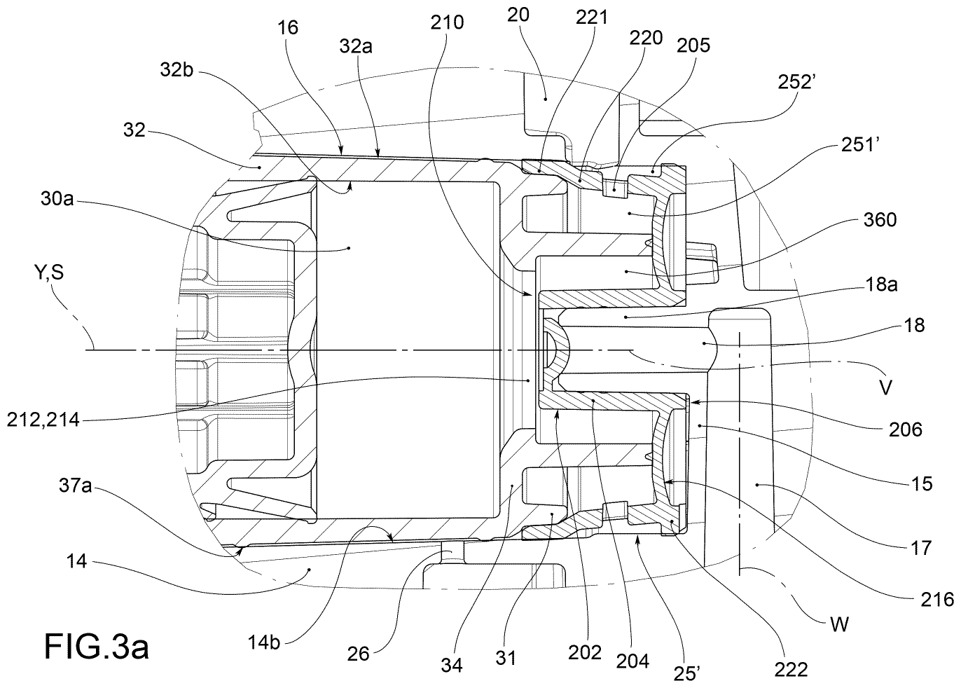

FIG. 4 shows a cross-sectional view of a trigger dispensing head according to a different embodiment of the present invention;

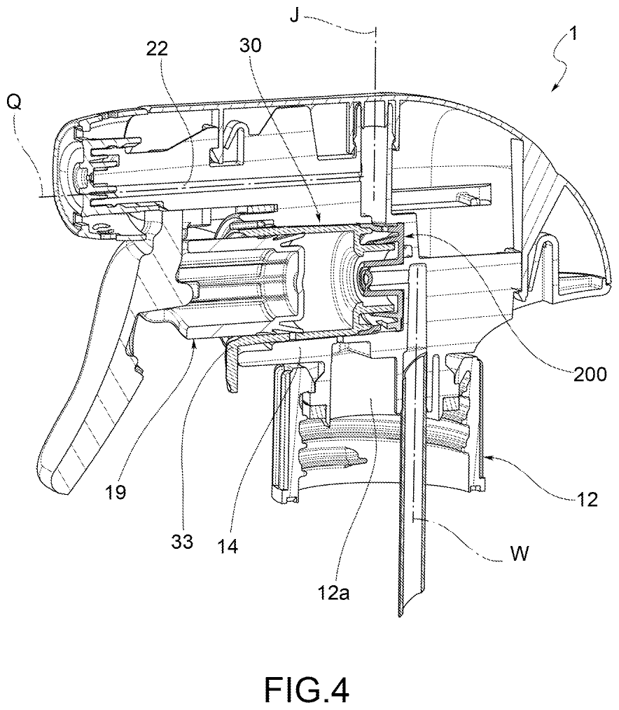

FIG. 4a shows an enlarged detail of FIG. 4;

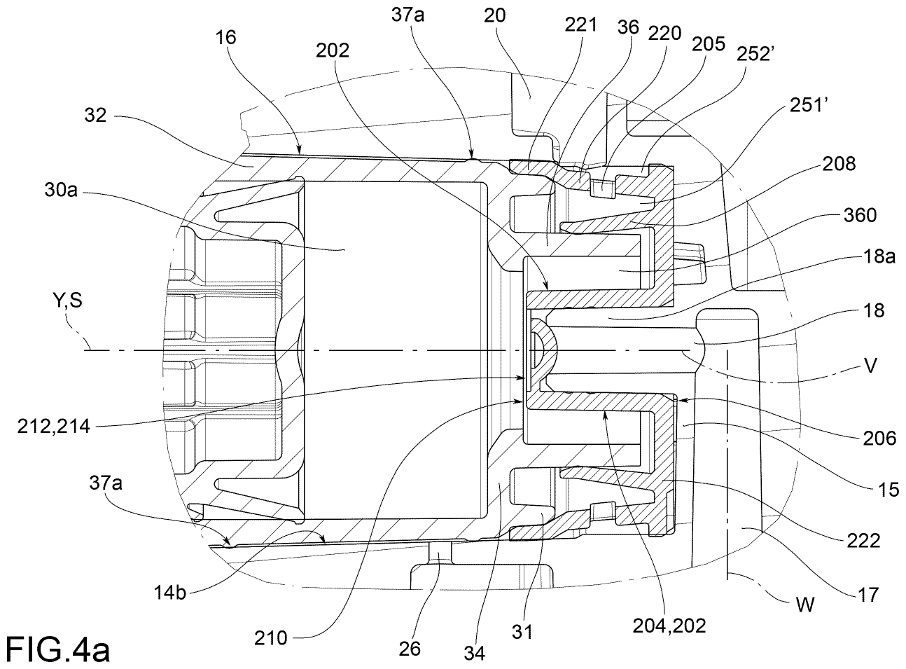

FIG. 5 depicts an enlarged detail of a sectional view of a trigger dispensing head according to a still further embodiment;

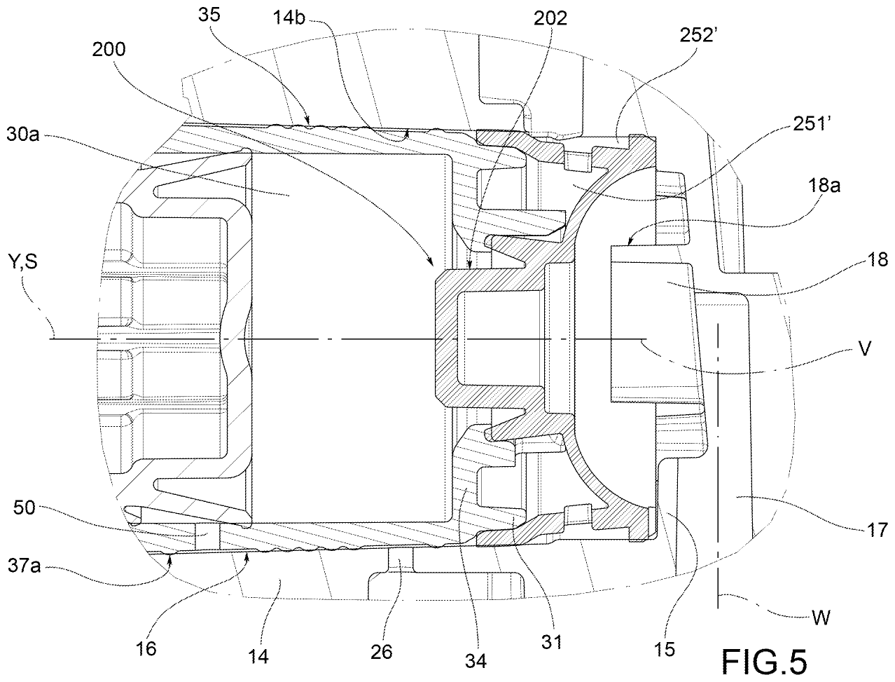

FIG. 5a shows the valve element of the dispensing head of FIG. 5;

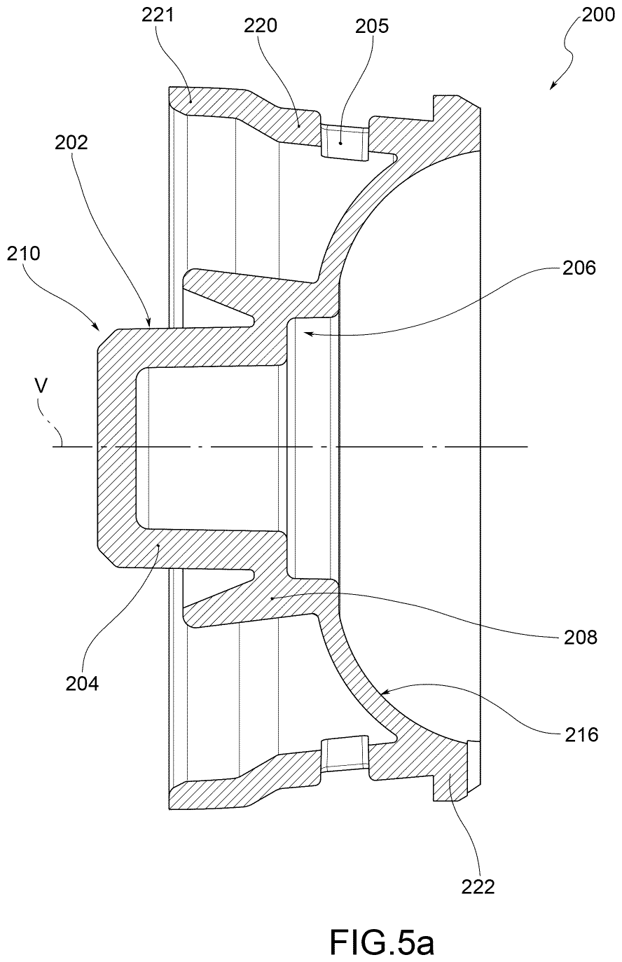

FIGS. 6 and 6a show, respectively, a side view and an axonometric view of the sleeve of the dispensing head, according to one embodiment;

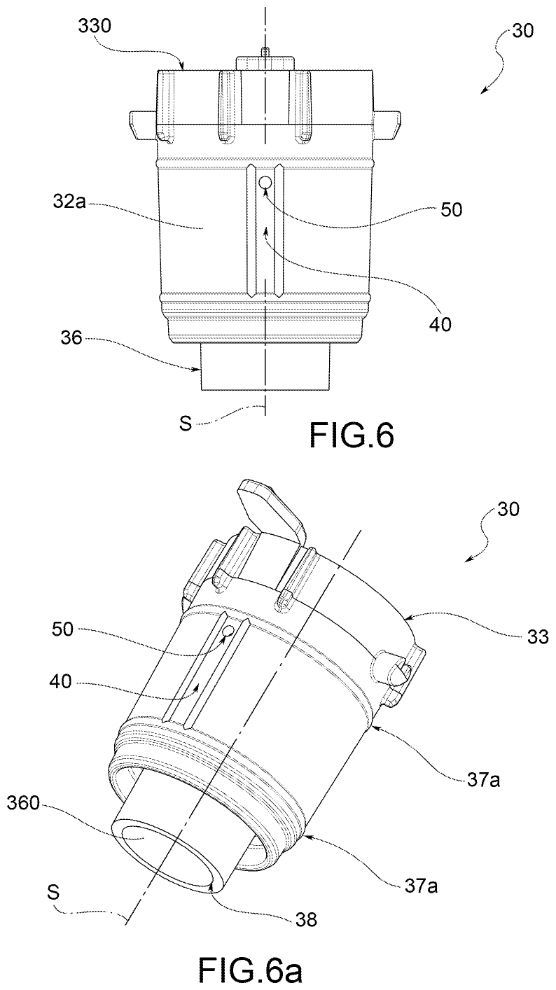

FIG. 7 represents a cross-sectional view of a trigger dispensing head according to the prior art.

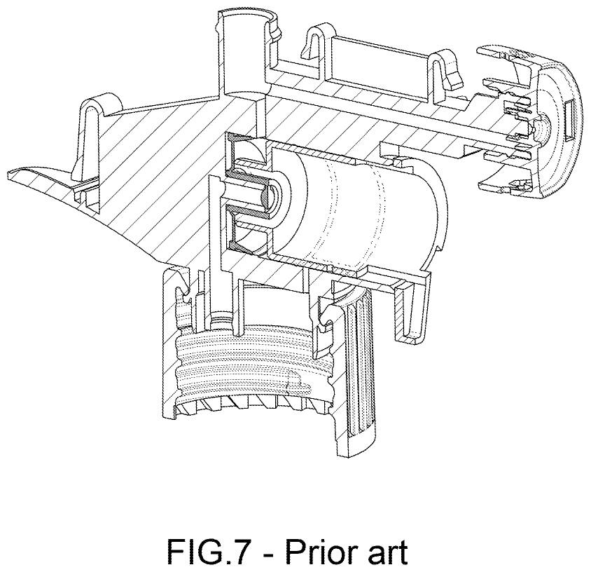

### DETAILED DESCRIPTION OF AN EMBODIMENT

With reference to the figures of the attached drawings, the numeral 1 denotes, in the entirety thereof, a dispensing head according to the present invention and the numeral 100 denotes, in the entirety thereof, a dispensing device comprising a dispensing head 1 and a bottle 2.

The dispensing head 1 may be applied to the bottle 2 of the dispensing device 100, for example by means of a threaded, snap-on or bayonet connection.

The dispensing head 1 includes a frame 10 for supporting components, preferably made in one piece, for example from a plastics material by injection molding.

The frame 10 is manufactured from a first material, in particular a rigid material, preferably a material belonging to the polyolefin family, for example polypropylene (PP).

The frame 10 comprises an attachment portion 12 provided with a main opening 12a. Once the dispensing head has been applied to the bottle 2, the main opening 12a is fluidly connected to an inner compartment of the bottle 2 that is suitable for containing a product to be dispensed.

The frame 10 comprises a cylinder wall 14 having an annular inner surface 14b around a chamber axis Y, which surface delimits a cylinder chamber 16.

The cylinder wall 14 has a main vent passage 26 that places the main opening 12a in communication with the cylinder chamber 16, and in particular with the inner surface 14b.

The frame 10 also comprises a bottom wall 15 that is incident to the cylinder wall 14 and that axially delimits the cylinder chamber 16.

The dispensing head 1 comprises a suction duct that places the inner compartment of the bottle 2 in communication with the pressure chamber 30a.

According to one embodiment, the suction duct comprises a first suction section 17 that, from the main opening 12a, extends along a first suction axis W, preferably incident to the chamber axis Y, and a second suction section 18 that is in communication with the cylinder chamber 16, preferably parallel to the chamber axis Y.

According to one embodiment, the second suction section 18 is delimited by a suction mouth 18a, preferably projecting from the bottom wall 15.

The dispensing head 1 further comprises a dispensing duct that places the cylinder chamber 16 in communication with the external environment.

According to one embodiment, the dispensing duct comprises a first suction section 20 that, from the cylinder chamber 16, extends along a first dispensing axis J, preferably incident to the chamber axis Y, and a second dispensing section 22 that extends along a second dispensing axis Q, for example parallel to the chamber axis Y, and that opens out into the external environment.

The dispensing head 1 comprises a nozzle that is applied to a dispensing end of the dispensing duct. The nozzle, preferably manufactured as one piece, is configured to be maneuvered, for example rotated, between an open nozzle position and a closed nozzle position.

The International Application WO-A1-2015/145399 in the name of the Applicant describes an embodiment of the nozzle.

The dispensing head 1 comprises a piston 19 and a trigger 11 supported by the frame 10 and manually operable in order to move the piston 19 between a rest position and an end-of-stroke position.

Further details regarding the trigger and the piston are, for example, described in the Italian patent application No. 102021000017402 in the name of the Applicant.

The dispensing head 1 comprises a sleeve 30, inserted into the cylinder chamber 16, comprising a sleeve axis S and an annular sleeve wall 32 around the sleeve axis S that delimits a pressure chamber 30a.

The sleeve wall 32 has an outer surface 32a radially facing the inner surface 14b of the cylinder wall 14, and an inner surface 32b radially facing the pressure chamber 30a.

The sleeve 30 is manufactured from a second material, in particular a rigid material, preferably a material belonging to the polyolefin family, for example polypropylene (PP).

The sleeve 30 has a secondary vent passage 50 passing through the sleeve wall 32, which passage is open on the outer surface 32a.

The sleeve wall 32 terminates axially with an opening edge 33 that defines a bottom sleeve opening 330 facing the external environment.

The piston 19 is inserted into the pressure chamber 30a and slidingly engages the inner surface 32b of the sleeve wall 32 to form a seal. In other words, the piston 19 axially delimits, at least partially, the pressure chamber 30a.

The sleeve 30 comprises a head wall 34 that axially defines the pressure chamber 30a.

The head wall 34 is incident, for example orthogonal, to the sleeve axis S.

The sleeve 30 comprises a terminal wall 36 that is radially lowered in relation to the sleeve wall 32.

Preferably, the terminal wall 36 axially projects from the head wall 34.

The terminal wall 36 annularly defines a terminal compartment 360 in communication with the pressure chamber 30a.

The terminal wall 36 terminates t with head aperture 38.

The sleeve 30 and cylinder wall 14 delimit, at least partially, a valve compartment 25′.

Preferably, the valve compartment 25′ is delimited within the cylinder chamber 16.

Preferably, the valve compartment 25′ is axially delimited by the head wall 34. Preferably, the valve compartment 25′ is axially delimited by the bottom wall 15.

According to one embodiment, the valve compartment 25′ is annularly delimited by the terminal wall 36.

In other words, preferably, the valve compartment 25′ has an annular shape around the terminal wall 36.

With the sleeve 30 inserted into the cylinder chamber 16, the suction duct is in communication with the pressure chamber 30a.

In particular, with the sleeve 30 inserted into the cylinder chamber 16, the suction duct opens out into the terminal compartment 360. Preferably, the suction mouth 18a crosses the head aperture 38.

Additionally, with the sleeve 30 inserted into the cylinder chamber 16, the dispensing duct is in communication with the pressure chamber 30a.

In particular, the dispensing duct, for example the first dispensing section 20, is open and extends from the valve compartment 25′.

According to one embodiment, the sleeve 30 is housed in a fixed angular position within the cylinder chamber 16 in relation to the chamber axis Y.

According to a different embodiment, the sleeve 30 is housed within the cylinder chamber 16 such that it is free to rotate around the chamber axis Y.

The sleeve 30 and the cylinder chamber 16 are reciprocally engaged to form a seal in order to impede leakages of liquid between the outer surfaces 32a of the sleeve 30 and the inner surface 14b of the cylinder wall 14.

According to one embodiment, the sleeve 30 comprises a plurality of mechanical seals, for example circumferential seals 37a and or axial seals projecting from the outer surface 32a. The mechanical seals delimit a connection region 40 into which the secondary vented passage 50 emerges that is suitable for placing the main vent passage 26 in communication with the external environment.

Further details are described in the Italian patent application No. 102021000003749 in the name of the Applicant.

According o one embodiment, the sleeve 30 comprises a labyrinth seal 35 which extends over the outer surface 32a and is suitable for placing the main vent passage 26 in communication with the external environment.

Further details are described in the Italian patent application No. 102021000017402 in the name of the Applicant.

According to one embodiment, the sleeve 30 comprises a sealing member 31 facing the valve compartment 25′.

According to one embodiment, the sealing member 31 is radially lowered in relation to the sleeve wall 32, in relation to the sleeve axis S.

According to one embodiment, the sealing member 31 is detached from the inner surface 14b of the cylinder chamber 14.

According to one embodiment, the sealing member 31 is arranged radially externally to the terminal wall 36, in relation to the sleeve axis S.

According to one embodiment, the sealing member 31 has a circular crown shape around the sleeve axis S.

According to one embodiment, the sealing member 31 projects from the valve compartment 25′.

According to one embodiment, the sealing member 31 projects radially in relation to the head wall 34 of the sleeve 30.

The dispensing head 1 comprises valve means for adjusting the product flow from the suction duct to the pressure chamber 30a, during a suction step, and/or for adjusting the product flow from the pressure chamber 30a to the dispensing duct, during a dispensing step.

The valve means comprise a valve element 200 that is accommodated, at least partially, in the valve compartment 25′.

The valve element 200 comprises a support wall 220 made from an elastically deformable material that is engaged between the sleeve 30 and the cylinder wall 14 in order to form a seal against leakage of the product from the valve compartment 25′.

In other words, the support wall 220 cooperates with the sleeve 30 and with the cylinder wall 14 in order to prevent losses of product between the outer surface 32a of the sleeve 30 and the inner surface 14b of the cylinder wall 14.

Preferably, the support wall 220 is made from a material that is different from the first material of the frame 10.

Preferably, the support wall 220 is made from a material that is different from the second material of the sleeve 30.

In one embodiment, the support wall 220 is made from EVA (ethyl-vinyl-acetate), LDPE (low-density polyethylene, a member of the polyolefin family) or TPE (thermoplastic elastomer).

According to one embodiment, the valve element 200 has a valve axis V and the support wall 220 has an annular shape around the valve axis V.

According to one embodiment, the support wall 220 engages, at least partially, with the head wall 34 of the sleeve 30 in order to form a seal between the head wall 34 and the cylinder wall 14.

According to one embodiment, the support wall 220 comprises a free end 221 that is at least partially elastically deformable.

According to one embodiment, the free end 221 is arranged between the sealing member 31 of the sleeve 30 and the inner surface 14b of the cylinder wall 14.

According to one embodiment, the sealing member 31 cooperates with the inner surface 14b in order to elastically deform, at least partially, the support wall 220, in particular the free end 221.

According to one embodiment, the sealing member 31 is configured so as to pinch the free end 221 with the inner surface 14b of the cylinder wall 14.

The support wall 220 divides the valve compartment 25′ into a first valve half-compartment 251′, which is fluidly connectable to the pressure chamber 30a, and a second valve half-compartment 252′, which is in communication with the dispensing duct.

The valve element 200 comprises at least one valve opening 205 passing through the support wall 220, which valve places the first half-compartment 251′ in communication with the second valve half-compartment 252′.

Preferably, the valve element 200 comprises two valve openings 205, which are for example diametrically opposite.

In one embodiment, the support wall 220 is radially tapered outwards, for example towards the front end 210 of the valve element 200.

According to one embodiment, the valve element 200 comprises a valve base 222 arranged in contact with the bottom wall 15, and the support wall 220 extends from the valve base 222.

The valve means comprise suction valve means configured to operate between a closing position, assumed in the dispensing configuration of the dispensing head, in which the suction and the passage of the product towards the inner compartment of the bottle 2 are prevented, and an opening position, assumed in a suction configuration of the dispensing head, in which suction is permitted.

According to one embodiment, the valve element 200 comprises a central portion 202 that extends in relation to the valve axis V.

Preferably, the central portion 202 is tubular around the valve axis V.

According to one embodiment of the suction valve means, the central portion 202 comprises an annular valve wall 204 that extends axially between a rear end 206 and a front end 210.

According to one embodiment, the valve element 200 comprises a flexible flap 212 connected in a cantilevered manner to the front end 210 of the valve wall 204, projecting radially internally.

Preferably, the flap 212 has a shutter portion 214, which is for example flat or semi-spherical.

With the valve element 200 accommodated within the valve compartment 25′, the central portion 202 engages with the suction duct, in particular the valve wall 204 is fitted onto the second suction section 18 and the shutter portion 214 cooperates with the suction mouth 18a forming suction valve means.

According to a different embodiment of the suction valve means, the central portion 202 comprises a notch in the valve wall 204 with separable lips that form suction valve means.

The valve means comprise delivery valve means which are configured so as to operate between the pressure chamber 30a and the dispensing duct and are suitable, during the dispensing step, for passing the product from the pressure chamber 30a towards the dispensing duct. During the suction step, the delivery valve means are suitable for preventing the passage of air from the dispensing duct towards the pressure chamber 30a.

The valve means comprise pre-compression valve means that are configured so as to pass the product from the pressure chamber 30a to the dispensing duct only when the pressure within the pressure chamber 30a exceeds a predetermined threshold value.

According to one embodiment, the valve element 200 comprises a membrane 216 that cooperates with the sleeve 30, preferably with the terminal wall 36, thereby forming the delivery valve means.

In one embodiment, the membrane 216 is configured so as to elastically deform only when the pressure within the pressure chamber 30a exceeds a predefined pressure threshold value, thereby forming an example of pre-compression valve means.

Preferably, the membrane 216 is in contact with the head aperture 38 and closes the terminal compartment 360.

According to one embodiment, the membrane 216 extends radially around the central portion 202. Preferably, the membrane 216 is connected to the annular valve wall 204.

According to one embodiment, the support wall 220 extends radially outwards from the membrane 216.

According to one embodiment, the membrane 216 is concave facing towards the front end 210.

According to a different embodiment, the membrane 216 is substantially planar.

According to a different embodiment, the valve element 200 comprises an annular sealing lip 208, for example axially projecting from the valve base 222 and/or from the central portion 202, suitable for cooperating with the sleeve 30 in order to form delivery valve means.

In one embodiment, the lip 208 is configured so as to elastically deform only when the pressure within the pressure chamber 30a exceeds a predefined pressure threshold value, thereby forming an example of pre-compression valve means.

According to one embodiment, the sealing lip 208 is housed within the terminal compartment 360 and sealingly engages with an inner terminal surface of the terminal wall 36.

According to a different embodiment, the sealing lip 208 is radially external to the terminal wall 36 and sealingly engages with an outer terminal surface of the terminal wall 36.

In one embodiment, the sealing lip 208 is at least partially deformable in a radial direction, for example outwards, in order, upon exceeding the predefined pressure threshold value, to allow the product to pass during the dispensing step.

In a different embodiment, the sealing lip 208 is configured, upon exceeding the predefined pressure threshold value, so as to axially translate in order to allow the product to pass during the dispensing step.

According to one embodiment, the valve element 200 is made as one piece.

Preferably, the valve element 200 integrates as one piece both the suction valve means and the delivery valve means.

Preferably, the valve element 200 also integrates as one piece the pre-compression valve means.

In one embodiment, the valve element 200 is at least partially made from an elastically deformable material, for example it is at least partially manufactured from EVA (ethyl-vinyl-acetate), LDPE (low-density polyethylene, belonging to a member of the polyolefin family) or TPE (thermoplastic elastomer).

Preferably, the valve element 200 is made from a material that is different from the first material of the frame 10.

Preferably, the valve element 200 is made from a material that is different from the second material of the sleeve 30.

The International Applications WO-A1-2012069939, WO-A1-2014/013352 and WO-A1-2022112889, in the name of the Applicant, describe examples of pre-compression valve means and suction valve means.

The subject matter of the invention is also a dispensing device 100 comprising a bottle 2 having an inner compartment for containing the liquid to be dispensed, and a dispensing head 1 applied to the bottle 2, for example by snapping or screwing onto the neck of the bottle 2.

The sleeve 30 is accommodated into the cylinder chamber 16 in a fixed position along the chamber axis Y.

The piston 19 is housed in a translatable manner within the pressure chamber 30a of the sleeve 30 along the sleeve axis S.

The sleeve 30 is a component that is distinct from the frame 10, for example it is separable from the cylinder wall 14, for example it is removable from the cylinder chamber 16.

Preferably, the sleeve 30 is made as one piece.

Innovatively, the dispensing head and the dispensing device described above satisfy the requirements of the sector insofar as they form an efficient system for sealing against leakage of product from the valve chamber of the valve means.

Advantageously, in cooperating with the sleeve, the valve element forms a seal against losses of product that is more reliable compared to solutions of the prior art.

Advantageously the valve element integrates as one piece the pre-compression valve means and the suction valve means.

Advantageously a seal is also ensured when using a sleeve that is rotatable in the cylinder chamber.

It is understood that a person skilled in the art, in order to meet contingent needs, could make modifications to the dispensing head described above, all of which are contained within the scope of protection as defined by the following claims.

For example, according to an embodiment variant, the suction valve means comprise a shutter sphere that cooperates with the suction duct.

For example, according to an embodiment variant, the suction duct faces an inner region of the cylinder chamber and the dispensing duct faces an outer region of the cylinder chamber, in relation to the chamber axis.

1-17. (canceled)

18. A trigger dispensing head applicable to a bottle of a dispensing device for dispensing a product, comprising:
a cylinder wall having an annular inner surface that extends along and around a chamber axis and delimits a cylinder chamber;
a sleeve accommodated in the cylinder chamber in a fixed position along the chamber axis, comprising an annular sleeve wall having an outer surface and delimiting a pressure chamber, wherein the sleeve and the cylinder wall at least partially delimit a valve compartment;
a piston that is translatable in the pressure chamber between an initial rest position and a final end-of-stroke position;
a suction duct suitable for putting a compartment inside the bottle in communication with the pressure chamber, and a dispensing duct suitable for putting the pressure chamber in communication with an external environment; and
valve means suitable for adjusting a flow of the product from the suction duct to the pressure chamber during a suction step and/or for adjusting a flow of the product from the pressure chamber to the dispensing duct during a dispensing step, and comprising a valve element at least partially housed in the valve compartment, the valve element comprising an annular support wall made of elastically deformable material engaged between the sleeve and the cylinder wall to make a seal against leakage of the product from the valve compartment, wherein
the annular support wall cooperates with the sleeve and with the cylinder wall to prevent leakage of product between the outer surface of the sleeve and the annular inner surface of the cylinder wall.

19. The trigger dispensing head of claim 18, wherein the sleeve further comprises a head wall, incident to the annular sleeve wall, at least partially delimiting the valve compartment, and wherein the annular support wall engages the head wall to make a seal between the head wall and the cylinder wall.

20. The trigger dispensing head of claim 18, wherein the sleeve further comprises a sealing member facing the valve compartment and detached from the annular inner surface, and wherein the annular support wall comprises a free end placed between the sealing member and the annular inner surface.

21. The trigger dispensing head of claim 19, wherein the sleeve further comprises a sealing member facing the valve compartment and detached from the annular inner surface, wherein the annular support wall comprises a free end placed between the sealing member and the annular inner surface, and wherein the sealing member protrudes past the head wall into the valve compartment.

22. The trigger dispensing head of claim 20, wherein the sealing member is configured to pinch the free end with the annular inner surface.

23. The trigger dispensing head of claim 20, wherein the sealing member has a circular crown shape.

24. The trigger dispensing head of claim 18, wherein the annular support wall divides the valve compartment into a first valve half-compartment fluidly connectable to the pressure chamber, and a second valve half-compartment in communication with the dispensing duct.

25. The trigger dispensing head of claim 24, wherein the valve element comprises at least one valve opening in the annular support wall.

26. The trigger dispensing head of claim 18, further comprising a bottom wall, incident to the cylinder wall, at least partially delimiting the valve compartment, wherein the valve element comprises a valve base in contact with the bottom wall, and wherein the annular support wall axially extends from the valve base.

27. The trigger dispensing head of claim 18, wherein the cylinder wall is made of a first rigid material and the annular support wall is made of an elastically deformable material with respect to the first rigid material of the cylinder wall.

28. The trigger dispensing head of claim 18, wherein the annular sleeve wall is made of a second rigid material and the annular support wall is made of an elastically deformable material with respect to the second rigid material of the annular sleeve wall.

29. The trigger dispensing head of claim 27, wherein the first rigid material belongs to the family of polyolefins, optionally the polyolefins being polypropylene.

30. The trigger dispensing head of claim 27, wherein the elastically deformable material is selected from the group consisting of ethylene-vinyl acetate (EVA), low-density polyethylene (LDPE), and thermoplastic elastomer (TPE).

31. The trigger dispensing head of claim 28, wherein the second rigid material belongs to the family of polyolefins, optionally the polyolefins being polypropylene.

32. The trigger dispensing head of claim 28, wherein the elastically deformable material is selected from the group consisting of EVA, LDPE, and TPE.

33. The trigger dispensing head of claim 18, wherein the valve element further comprises a central portion that extends with respect to a valve axis, and a flexible flap that cooperates with a suction mouth to provide suction valve means.

34. The trigger dispensing head of claim 18, wherein the valve element further comprises an elastically deformable membrane that cooperates with the sleeve to provide delivery valve means and/or pre-compression valve means.

35. The trigger dispensing head of claim 18, wherein the valve element further comprises an elastically deformable or translatable sealing lip to provide delivery valve means and/or pre-compression valve means.

36. The trigger dispensing head of claim 18, wherein the valve element comprises both suction valve means to draw the product into the pressure chamber and delivery valve means to cause the product to flow towards the dispensing duct, and wherein the annular support wall is radially tapered outwards.

37. A dispensing device comprising:
a bottle for containing a product to be dispensed; and
the trigger dispensing head of claim 18, engaged with the bottle.
